(19) United States
(12) Patent Application Publication
(10) Pub. No.: US 2013/0247401 A1
(43) Pub. Date: Sep. 26, 2013

(54) SYSTEMS AND METHODS FOR MOUNTING PICTURE FRAMES

(71) Applicant: David Miller, San Antonio, TX (US)

(72) Inventor: David Miller, San Antonio, TX (US)

(21) Appl. No.: 13/430,573

(22) Filed: Mar. 26, 2012

(51) Int. Cl. A47B 81/00; G01C 9/10; G01C 9/24; B23P 11/00

(52) U.S. Cl. 33/379; 29/428; 211/41.1; 33/365

(57) ABSTRACT

A frame assembly is provided for easily hanging a frame at a desired orientation. The base frame has a central mount that is fastened to a wall, to permit the base frame to be rotated to the desired orientation. Off-center mounts are thereafter fastened to the wall to maintain the desired orientation. The base frame is configured to fit within an outer frame, which holds an artistic or functional insert. Once the outer frame is mounted over the base frame, the base frame is obscured and the outer frame is flush with the wall surface. Further, multiple base frames can be hung in alignment by simply marking the desired center point for each base frame. The outer frame is removably secured to the base frame by a catch, to permit the easy exchange of the artistic insert or outer frame.

### FIELD OF THE INVENTION

The field of the invention relates to devices used to secure an object onto a support structure, and more particularly to systems and methods for mounting a frame on a wall or other surface for displaying functional or decorative items.

### BACKGROUND

It is common for people to hang functional or decorative items as for example pictures, artwork, documents, mirrors and other insert items on walls. Conventional hanging systems include frames that generally mount at an angle from the wall using various mounting approaches including wires and nails, picture hooks, screws and wall anchors, etc., to hang the item from the wall. These mounting approaches leave a gap between the frame and the wall and do not balance the frame relative to the center of gravity of the frame and its contents. Consequently, wall hangings especially framed pictures tend to tilt and shift relative to their desired position when hung from the wall.

It is also common for people to either replace an artwork from a wall hanging or change the ornamental frame and keep the artwork. In these situations, the frames need to be disassembled, reassembled and many times it is desired to position the newly framed artwork at the same location on the wall. In certain situations it is also desirable to mount multiple frames in a patterned arrangement on the wall. In these situations, having the ability to mount frames at precise angles and distances becomes essential in maintaining the pattern.

One problem with the commonly used frames is the high cost associated with time required for disassembling and reassembling the frames to replace the artwork or the frame itself. Another common problem is that used frame assemblies, once removed from the wall, are difficult to accurately level and precisely reposition without having to make new holes in the wall.

None of the prior art frame assemblies sufficiently address the above problems. For example, U.S. Pat. No. 6,354,031 to Meur describes a two piece frame assembly where a back panel is mounted on the wall and a frame surrounds the panel. The picture is placed between the frame and the back element. However in Meur, a space is left between the wall and the frame and the configuration of the panel does not allow for accurate leveling and placement of the frame. Another example includes U.S. Pat. No. 6,035,571 to Hsu, which describes a three piece frame assembly for displaying a picture. In Hsu, a back plate has a recess and a plurality of holes, and is connected to an ornamental intermediate plate with adhesive. The picture is placed between an additional face plate and the intermediate plate. Here, the back plate is not configured to flush mount against the wall or to provide for accurate leveling and placement of the frame. Even further, it would be time consuming to disassemble the intermediate plate from the back plate in order to allow for interchangeability of either plate.

Thus, there is still a need for a frame assembly capable to receive an item, adapted to securely and precisely flush mount against a support and having a decorative component that is easily interchanged without having to change the configuration of the frame assembly.

### SUMMARY A THE INVENTION

A frame assembly for displaying a decorative or functional insert is provided. The frame assembly includes a base frame and an outer frame. The base frame has a central mounting aperture drilled through the center of the base frame and at least one off-center mounting aperture drilled through the base frame at a point away from the central mounting aperture. A center fastener is inserted through the central mounting aperture, such that the base frame is permitted to rotate about the center fastener. Once the base frame is rotated to the desired orientation, preferably by using a level indicator, the off-center fasteners can be inserted through the off-center mounting apertures and into the support to prevent further rotation and maintain the desired orientation.

The outer frame has a display aperture to permit the viewing of the insert. A rabbet is formed on the back of the outer frame, cut around the perimeter of the display aperture. The rabbet is sufficiently sized to receive at least a portion of the base frame. Once the base frame is fastened to the support, the outer frame is mounted on the base frame, with the base frame fitting within the rabbet.

### BRIEF DESCRIPTION OF THE DRAWINGS

FIG. 1 is a perspective view of the frame assembly mounted to a wall;

FIG. 2 is a side plan view of the frame assembly mounted to a wall;

FIG. 3 is a perspective view of the base frame;

FIG. 4 is a front perspective view of the outer frame;

FIG. 5 is a back perspective view of the outer frame;

FIG. 6 is a front perspective exploded view of the frame assembly with the mounting position in phantom;

FIG. 7 is a back perspective exploded view of the frame assembly with the wall and the mounting position in phantom;

FIG. 8 is a perspective view of the base frame mounted to a wall with curved arrows showing rotation;

FIG. 9 is a sectional view of the frame assembly mounted to a wall, with the section taken through the middle of the vertical cross member;

FIG. 10 is a sectional view of the frame assembly of FIG. 9, with the dent area shown magnified; and

FIG. 11 is a front plan view of the bob optionally used for leveling the frame assembly with respect to gravity.

### DETAILED DESCRIPTION

In FIG. 1, the frame assembly (10) is shown fully assembled and mounted on a flat surface (20) of the support (16). The support can be any structure appropriate for mounting and supporting a frame, such as a wall or easel. The frame assembly (10) has an outer frame (12) configured to be coupled to a base frame (14). An insert (18) is interposed between a transparent panel (36) and the base frame (14). The base frame (14) acts as a support bracket for the remainder of the assembly, where the base frame (14) is attached directly to the support (16) and the outer frame (12), the insert (18), and the transparent panel (36) are supported on the base frame (14). The transparent panel (36) can be a glass, plastic, or other desired panel that permits the display of the insert (18) beneath. The insert (18) can be an artwork, document, mirror, or any other work that can fit within the assembly. It can be appreciated that a three-dimensional insert can be placed in the frame assembly (10), given adequate space is provided with simple changes in frame thickness, transparent panel (36) shape, and other dimensions.

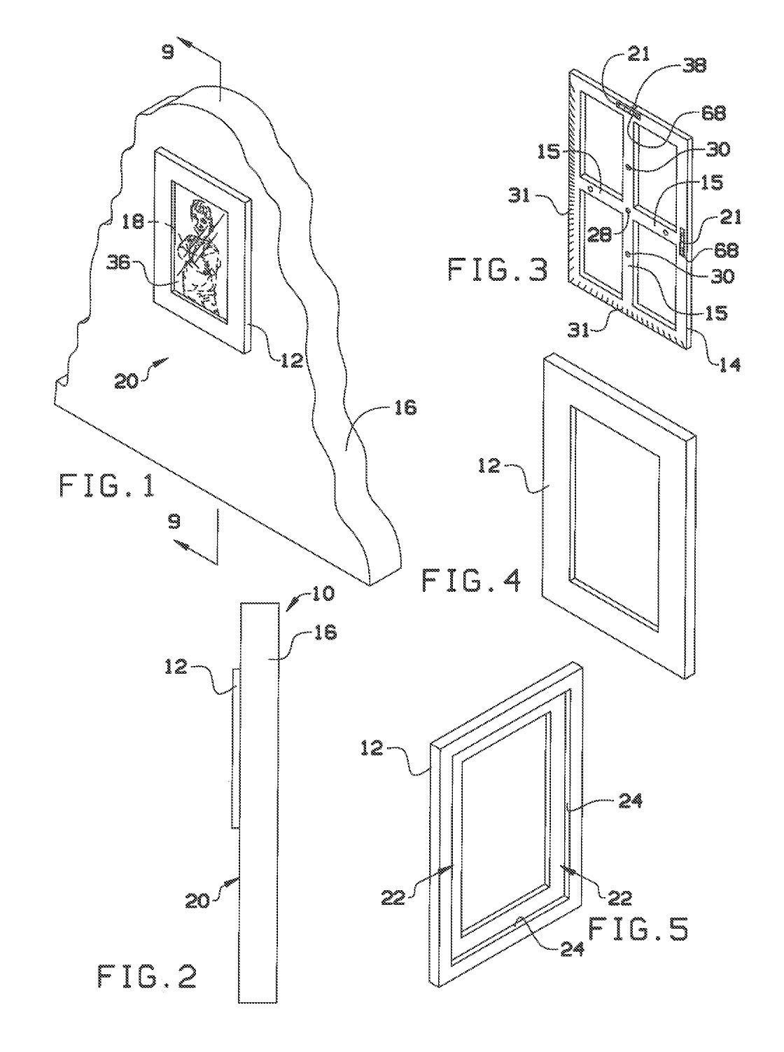

Looking to FIG. 2, the frame assembly (10) is shown mounted to a support (16). It should be noted that the outer frame (12) is flush with the flat surface (20) of the support (16) wall. Unlike traditional frames that are known to hang away from the wall, the present frame assembly (10) preferably contacts the wall at every point, such that it does not tilt away from the flat surface (20) of the wall.

The details of the base frame (14) can be more clearly viewed in FIG. 3. In this example embodiment, the base frame (14) is generally rectangular, with vertical and horizontal cross members (15). Other base frame (14) shapes can be utilized, including square, circular, triangular, or any other desired shape, depending on decorative or structural choices. Further, even though the base frame (14) and the outer frame (12) are shown as being complementary in shape, the base frame (14) could be square while the outer frame (12) is round or any other desired combination. It is usually desirable that the outer frame (12) completely cover the base frame (14) for decorative reasons, although this is not required.

The base frame (14) can be a solid sheet of material, however, it is shown herein as a rectangular frame with a vertical and a horizontal cross member (15), leaving four square spaces, which can be used as viewing ports during the hanging process. At the intersection of the vertical and horizontal cross members (15) a central mounting aperture (28) is drilled through the base frame (14). The location of the central mounting aperture (28) is at the center of the base frame (14), at the midpoint on the axis of symmetry, where the base frame (14) can be rotated in ninety degree increments without substantially changing the location of the central portion of the display insert. The central mounting aperture (28) may be countersunk, so that the head of the central fastener (32) is located beneath the surface of the base frame (14). Further, four off-center mounting apertures (30) are drilled away from and about the central mounting aperture (28). In this example embodiment, each of the four off-center mounting apertures (30) are located an equal distance from the central mounting aperture (28). Once the support (16) wall has been drilled with the five mounting holes, the present off-center mounting aperture (30) arrangement permits the user to rotate the base frame (14) in ninety degree increments, without drilling new holes in the support (16) wall.

To aid in leveling or positioning the base frame (14) at a desired angle, angle or gradient marks (31) may be printed about the outer perimeter of the base frame (14). These gradient marks (31) permit the use of traditional plumb-bob devices, where a bob is attached to a string. The plumb-bob may be hung from the central mounting aperture (28) or other portion of the center line, with the string indicating a vertical plum-line. The desired angle is achieved by rotating the base frame (14) until the string aligns with the gradient mark (31) corresponding with the desired hang angle. It is preferred that the gradient marks (31) be printed about two adjacent sides of the base frame (14), so that the base frame (14) may be levelly hung in a landscape or portrait orientation. Level indicators (21), such as bubble levels, may be provided to aid in level hanging. Two level indicators (21) are shown imbedded in two adjacent sides, at perpendicular orientations with respect to one another, so that the base frame (14) may be levelly hung in a landscape or portrait orientation.

FIGS. 4-5 show the outer frame (12) separate from the frame assembly (10), with FIG. 4 showing the front fascia or decorative portion of the outer frame (12) and FIG. 5 showing the back portion of the outer frame (12). The outer frame (12) is shown with a display aperture or window cut through, so that the insert (18) may be viewed. A square notch or rabbet (22) is cut about the perimeter of the display aperture on the back portion of the outer frame (12). The rabbet wall (24) shows that the rabbet (22) is of sufficient depth to receive at least a portion of the base frame (14). Preferably, the dimension of the rabbet wall (24) is slightly more that the thickness of the base frame (14), so that the outer frame (12) may be mounted on the base frame (14), leaving no gap between the outer frame (12) and the flat surface (20) of the wall. The rabbet (22) is shaped complementary to the base frame (14), so that the base frame (14) may be wholly or partially situated within the rabbet (22) after assembly. The depth of the rabbet (22) may be increased to accommodate the insertion of the transparent panel (36) or backing, where the transparent panel (36) lies at the bottom of the rabbet (22), with the insert (18) laid above, and the base frame (14) providing sufficient hacking to hold the two within the frame assembly (10).

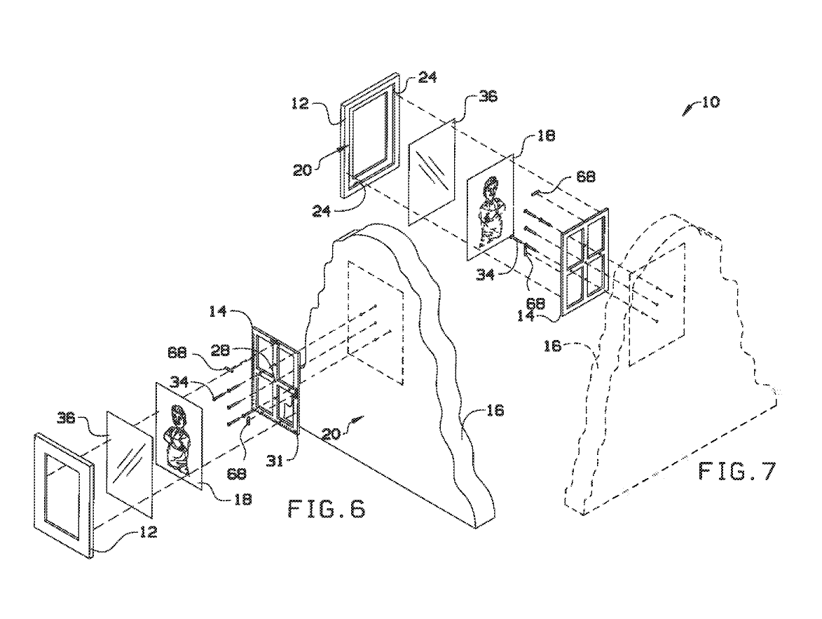

FIGS. 6-7 show the frame assembly exploded away from the support (16), with the five drilled holes in the support (16) corresponding to the four off-center mounting holes (30) and the central mounting aperture (28). Four off-center fasteners (34) and one center fastener (28) secure the base frame (14) to the support (16).

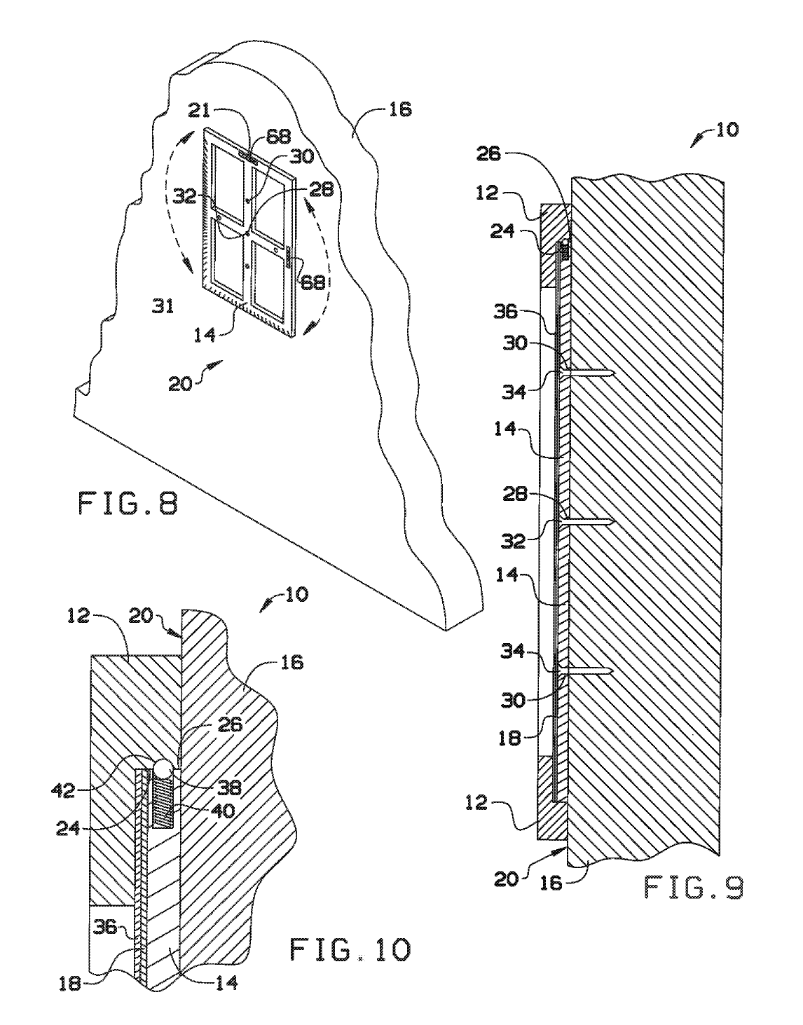

Looking now at FIGS. 8-10, the center fastener (28) is inserted though the central mounting aperture (28) and into the support (16), to pivotally secure the base frame (14) to the support (16). The curve arrows on either side of the base frame (14) indicate the angular rotation permitted by the securing of just the center fastener (28). The user is permitted to rotate the frame about the center fastener (28), until the desired orientation is achieved. Thereafter, the four off-center fasteners (34) are inserted through the off-center mounting holes (30) and into the support (16), to prevent further rotation of the base frame (14) and maintain the desired orientation. Although four off-center fasteners (34) are shown, just one off-center fastener need be secured through the base frame (14) to prevent further rotation.

FIGS. 9-10 show cross sectional views of the frame assembly (10) mounted to a support (16). In particular, FIG. 10 shows a magnified view of the catch or detent assembly, which includes a ball detent (38), a spring (40) to bias the ball detent (38) outwards, and a recess (42) formed in the rabbet wall (24) of the outer frame (12) that receives the hall detent (38), so that the outer frame (12) may be removably secured to the base frame (14). The bore which holds the detent assembly is formed in the outer edge (26) of the base frame (14). The user can simply push the outer frame (12) over the base frame (14), forcing the ball detent (38) inward and against the bias of the spring (40). Once the rabbet (22) has received the base frame (14), the recess (42) is brought into alignment with the ball detent (38), which permits the ball detent (38) to enter the recess (42) to secure the outer frame (12) to the base frame (14).

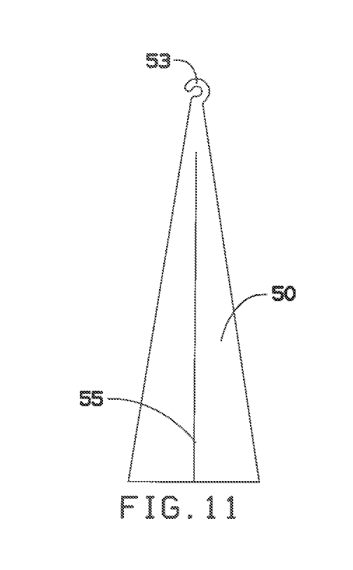

FIG. 11 shows a bob (50) with a hook (53) at the top and a plumb-line (55) marked on the surface of the bob (50) to indicate vertical with respect to gravity. The bob (50) can be hung from the center fastener (32) by hook (53), and permitted to freely hang and permit the plumb-line (55) to orient to vertical. The plumb-line (55) is compared to the gradient marks (31) formed about the base frame (14), and the base frame (14) rotated so that the desired orientation relative to vertical is achieved. The bob (50) may thereafter be removed.

Multiple base frames (14) may be easily hung in alignment by simply aligning the positions of the central mounting apertures (28) for each of the base frames (14). For example, if three base frames (14) were to be hung in horizontal alignment, equally spaced from one another, the user could simply mark a horizontal line across the wall, mark three center positions along the line with the two spaces between being equal. The center positions mark the position of the central mounting aperture (28) for each of the three base frames (14). Once the base frames (14) are mounted to the support (16), each can be rotated to the level position and fastened into place. In this way, the three pictures may appear to be in perfect alignment.

In a preferred embodiment the insert (18) is a decorative item, such as a painting, a picture, a drawing, a photograph, a lithograph, a printed image on canvas, and any other suitable art pieces. In other embodiments, the insert (18) is a functional item, such as a mirror, a blackboard, a whiteboard, a clock, a digital screen or any other suitable functional items. Yet in other embodiments, the insert (18) can be a combination of at least one decorative item and at least one functional item.

In a preferred embodiment the support (16) is a vertical wall or a ceiling wall having a flat surface (20). In other embodiments the support can be an upright support used for displaying an item, such as an easel.

The present frame assembly (10) permits the user to freely change outer frames (12) or the decorative insert (18). For example, a new decorative outer frame (12) can replace an old outer frame (12). A new art work insert (18) may replace a mirror insert (18) or an old art work insert. The present frame assembly (10) not only provides an easy method for accurately and levelly hanging a frame, it also permits the user to easily change the appearance and decorative nature of the outer frame (12) and insert (18) without undue trouble. The general hanging position and orientation of the frame assembly (10) is easily found by simply marking the desired center position on the support (16), then hanging the base frame (14) by the central fastener (32), and then rotating the base frame (14) into the level position.

What is claimed is:

1. A frame assembly for displaying an insert and configured to be fastened to a support using a center fastener and an off-center fastener, comprising:
a base frame having a central mounting aperture located through the center of the base frame, the central mounting aperture configured to receive the center fastener, the base frame having an off-center mounting aperture through the base frame at a location away from the center, the off-center mounting aperture configured to receive the off-center fastener; and
an outer frame having a display aperture to permit the viewing of the insert, a rabbet being formed on a back surface of the outer frame and cut around a perimeter of the display aperture, the rabbet being sized to receive the insert and at least a portion of the base frame;
wherein the base frame is fastened to the support through the fastening of the center fastener, the base frame being permitted to rotate about the center fastener until a desired frame angle is achieved;
and wherein the off-center fastener is fastened to the support to prevent further rotation and maintain the desired frame angle;
and wherein the outer frame is mounted on a front surface of the base frame, with an outer perimeter of the base frame fitting within the rabbet.

2. The frame assembly of claim wherein a level indicator is mounted on the base frame to aid in leveling the base frame.

3. The frame assembly of claim 2 wherein a first level indicator is mounted horizontally with respect to gravity and a second level indicator is mounted horizontally with respect to gravity.

4. The frame assembly of claim 2 wherein the level indicator is a bubble level.

5. The frame assembly of claim 1 wherein the base frame is releasably attached to the outer frame by a catch.

6. The frame assembly of claim 5 wherein the catch is a ball detent.

7. The frame assembly of claim 6 wherein the ball detent is installed within an outer edge of the base frame and configured to extend into a recess formed in the outer frame.

8. The frame assembly of claim 1 wherein a plurality of the off-center mounting apertures are formed through the base frame radially about the central mounting aperture, each of the off-center mounting apertures positioned equidistant from the central mounting aperture.

9. The frame assembly of claim 7 wherein a radial distance between each of the off-center mounting apertures is substantially ninety degrees, such that the base frame may be rotated in ninety degree increments and then refastened to the support.

10. The frame assembly of claim 1 wherein the rabbet is sized to receive a transparent panel, the insert, and the portion of the base frame.

11. A frame assembly for displaying an insert and configured to be fastened to a support using a center fastener and an off-center fastener, comprising:
a base frame having a central mounting aperture located through the center of the base frame, the central mounting aperture configured to receive the center fastener;
the base frame having a plurality of off-center mounting apertures formed through the base frame radially about the central mounting aperture, each of the off-center mounting apertures positioned equidistant from the central mounting aperture, each of the off-center mounting aperture configured to receive the off-center fastener; and
an outer frame having a display aperture to permit the viewing of the insert, the outer frame configured to be mounted over the base frame;
wherein the base frame is fastened to the support through the fastening of the center fastener, the base frame being permitted to rotate about the center fastener until a desired frame angle is achieved;
and wherein the off-center fastener is fastened to the support to prevent further rotation and maintain the desired frame angle;
and wherein the outer frame is mounted on a front surface of the base frame.

12. The frame assembly of claim 11 wherein four of the off-center mounting apertures are formed through the base frame, a radial distance between each of the off-center mounting apertures is substantially ninety degrees, such that the base frame may be rotated in ninety degree increments and then refastened to the support

13. A method of mounting a frame assembly for displaying an insert to a support, comprising the steps:
providing a base frame with a central fastening aperture and an off-center fastening aperture, and an outer frame configured to mount over the base frame and display the insert;
fastening the base frame to a support through just the central fastening aperture;
rotating the base frame about the central fastening aperture until a desired orientation is obtained;
fastening the base frame to the support through the off-center fastening aperture to maintain the desired orientation;
positioning the insert within the outer frame; and
mounting the outer frame over the base frame.
